(19) United States
(12) Patent Application Publication
(10) Pub. No.: US 2010/0138514 A1
(43) Pub. Date: Jun. 3, 2010

(54) METHOD AND DEVICE FOR DATA MANAGEMENT IN A DISTRIBUTED ENVIRONMENT

(75) Inventor: Emilien Charbonnier, La Cadiere d'azur (FR)

Correspondence Address: BUCHANAN, INGERSOLL & ROONEY PC, POST OFFICE BOX 1404, ALEXANDRIA, VA, 22313-1404, US

(73) Assignee: GEMALTO SA, Gemenos (FR)

(21) Appl. No.: 12/519,687

(22) PCT Filed: Dec. 19, 2007
(86) PCT No.: PCT/EP2007/064205

§ 371 Date: Feb. 16, 2010

(30) Foreign Application Priority Data
Dec. 20, 2006 (EP) 06301276.9

(51) Int. Cl. G06F 15/167; G06F 15/16

(52) U.S. Cl. 709/216; 709/217; 709/227

(57) ABSTRACT

The invention relates to a method for data management in a portable electronic device connected to a host machine, said device containing a first set of data, the host machine being connected to a remote data server containing a second set of data. Said method includes the steps of:
drawing up, in the device, a unique list containing the first and second sets of data,
transmitting the unique list from the device to the host machine.

### TECHNICAL FIELD

The present invention relates to methods and devices for data management in a distributed environment. More specifically, the invention relates to data management methods intended to provide a unified view of several sets of data stored on a plurality of devices.

### PRIOR ART

A portable electronic device such as a USB pen drive offers removable storage space, the size of which is limited by the size of the physical memory of the device. Such a device is connected to a host machine which can access the data stored on the device. The data stored on the device are data written in the local memory of the device.

On-line storage solutions are also known, which offer users much larger storage spaces at a lower cost. However, in the case of remote memory stored on remote servers, users have no guarantee that their data will be accessible, as may be the case with a device such as a USB pen drive.

On the other hand, users who want to simultaneously access data stored in a local data store and in a remote data store must use different views. These views allow the user to access the list of data according to each location. A view of the data stored in a local store does not contain the data stored in the remote data store and vice-versa.

Patent application WO02/01891 presents a method for managing data from several sources using a mobile telephone. This document proposes automating the choice of data location, by means of various media, during the data reading and writing phases. This automation is performed in the mobile telephone, using specific software to access the distributed data and create a unified view. This solution is not portable, remaining limited to telephones equipped with specific software.

USB pen drives commonly store data in file form. Conventionally, the file explorer on the host machine treats USE pen drives as removable disks. Such pen drives do not produce the represented view themselves; instead this view is generated by the software of the host machine. Generally speaking, the operating system of the host machine manages the file allocation table and a file explorer provides a view of this table. These pen drives are therefore passive and cannot offer a specific view of each of the files they contain, nor obviously of files stored in another volume.

On-line servers generate their own list of the files they host, and make this list available to an explorer located on a machine connected, following authentication, using protocols such as WEBDAV (Web-based Distributed Authoring and Versioning) or FTP (File Transfer Protocol), for example.

Existing software solutions do not present a unified view, but rather a simple view of the files at the location chosen by the user. Thus, if the user has a file in the root of his local data store, he cannot see the files located in the root of his remote data store in the same view. He must, in fact, open a second window or use a view with a conventional data-management tree-structure system.

One problem is that, in the prior art, methods for managing data from various media are implemented in the host machine, in particular in the mobile telephone, which acts as a host machine for portable storage devices. In addition, another problem is that the user cannot obtain a unique view of all the data from various media without installing a dedicated program on the host machine.

### SUMMARY OF THE INVENTION

The aim of the invention is to allow the user of a portable device to obtain a unified view that enables him to access, by means of a unique list, his data available on the portable device and stored on his remote server. The invention aims to provide a portable view that does not require the installation of specific new software on the host machine to which the portable device is connected.

The invention is a method for managing data of a portable electronic device connected to a host machine.

Said device contains a first set of data; the host machine is connected to a remote data server which contains a second set of data. The method includes the steps of:
drawing up, in the device, a unique list containing the first and second sets of data,
transmitting the unique list from the device to the host machine.

Preferably, a third set of data can be stored persistently on the device. This third set of data includes a list of the second set of remote data. The unique list (UL) can be drawn up according to these first and third sets of data.

Alternatively, the remote server can contain a fourth set of data listing the second set of data stored on the remote server. Drawing up the unique list can include the steps of:
setting up a data-exchange session between the device and the remote server via the host machine,
transmitting said fourth set of data from the remote server to the device,
drawing up the unique list using the first and fourth sets of data in the device.

Preferably, once a data-exchange session has been set up between the device and the remote server, the fourth set of data, listing the second set of data stored on the remote server, can be transmitted to the device. Then, the third set of data listing the second set of remote data stored on the remote server can be updated in the device according to the fourth set of data received.

Advantageously, following a request to read remote data emitted by the host machine, data stored on the remote server can be initially transmitted to the device by the server, and then be transmitted by said device to the host machine.

Alternatively, the unique list of data transmitted to the host machine can contain information indicating the location of each set of data in the list.

Preferably, access to the first set of data stored in the device can be subject to a verification of access conditions. In this case, setting up a data-exchange session between the device and the remote server can be subject to the successful verification of said access conditions.

Advantageously, the remote server can contain data relating to access conditions associated with a third set of data stored on the remote server. In this case, the verification of said access conditions can be automatically activated by the device.

Alternatively, the device can contain access information for the data of the remote server. In this case, after setting up a data-exchange session between said device and the remote server, the data relating to the access conditions can be transmitted to the device, and said access information for the data of the remote server can then be updated in the device according to the received data.

Advantageously, the data relating to the access conditions can be modified by a first device to authorise a second portable electronic device of the same type as the first device to access said second set of data.

Alternatively, the remote server can contain a fifth set of data listing the data stored on a second portable device. After setting up a data-exchange session between the first device and the remote server, the fifth set of data can be transmitted to the first device, and the third set of data listing the remote data can then be updated in the first device according to the fifth set of data received.

Alternatively, the remote server can contain access information for data stored on the second device. After setting up a data-exchange session between the first device and the remote server, the access information for the data stored on the second device can be transmitted to the first device. Then, the data containing access information for the remote data can be updated in the first device according to the received access information.

The invention also relates to a portable device intended for being connected to a host machine, including a microprocessor and a data store containing a first set of data. The host machine is intended for being connected to a remote server containing a second set of data. The device contains means for drawing up a unique list containing the first and second sets of data as well as means for transmitting the unique list to the host machine.

Preferably, the portable device can contain a third set of data listing the second set of data located on the remote server.

Advantageously, the portable device can contain access information for the data of the remote server.

Preferably, the portable device is a chip card or a USB pen drive for storing data.

The invention also relates to a server intended for being connected to a host machine, including a microprocessor and a data store containing remote data. The host machine is intended for being connected to portable device as previously mentioned. The device contains local data and the server contains means for transmitting a response to a request of the device, after setting up a data-exchange session between the device and the server. The response contains the data listing the remote data.

Other special features and advantages of the invention will become apparent from reading the description made as a strictly non-limiting example in relation to the following figures, in which:

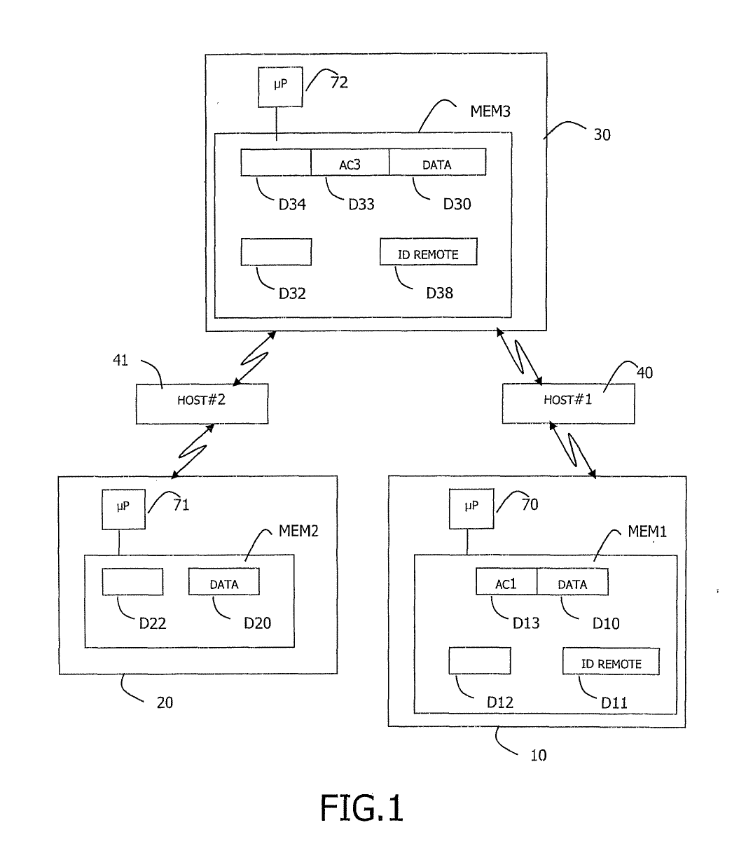

FIG. 1 shows a system comprising a server, two host machines, a chip card and a USB pen drive including means for managing distributed data;

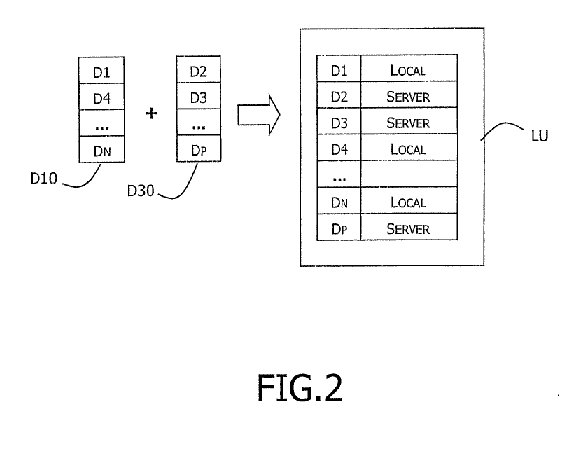

FIG. 2 shows an example of a unique list of the type produced in the context of the invention.

### DESCRIPTION OF A DETAILED EXAMPLE OF THE INVENTION

The invention is applicable to all types of portable electronic devices that connect to a host machine. In particular, it is applicable to portable secure digital devices containing a processor and one or more data stores, such as a USB pen drive, but also a chip card.

One advantage of the invention is that it allows the user of a portable electronic device to access data with a size that exceeds that of the data physically stored in the memory of the portable device. Part of the data can be stored on a remote server. According to the invention, the data can be accessed from any host machine connected to a network granting access to the remote data server on which the user data are stored.

According to a preferred embodiment, the data-management method is implemented by a chip card 10 and by a remote server 30, such as shown in FIG. 1. The chip card contains a microprocessor 70, a data store MEM1 containing application data D10, data D11 listing remote data and data D12 containing access information for the remote data. The remote server 30 contains a microprocessor 72, a data store MEM3 containing application data D30, data D34 listing the data stored on the server 30 and data D33 containing access information AC3 for the data stored on the server 30.

A host machine 40 is connected, on the one hand, to the chip card 10 and, on the other hand, to the remote server 30.

The host machine 40 can be, for example, a computer equipped with the software normally installed on this type of machine, such as an operating system, a file explorer and a web browser.

In the data stores MEM1 and MEM3 of the card 10 and the server 30 respectively, the data can be structured into files stored in a tree structure of folders.

When the host machine 40 needs to view the list of data in the chip card 10, the host machine 40 sends the chip card 10 a request to view the files. The chip card 10 then sets up a data-exchange session with the remote server 30 using the access gateway created by the host machine 40. The chip card 10 then requests the list of files it can access on the remote server 30. Next, the server sends the list of files corresponding to the chip card 10 via the host machine 40. The chip card 10 then draws up a unique list UL of files located on the actual card and on the server. This list UL can be drawn up in the form of a unified HTML view of the files. This HTML view is then sent to the host machine 40. Finally, the web browser of the host machine displays the unique list UL of the files in the form of a unified HTML view of files located on various media. The web browser can be, for example, Internet Explorer or Mozilla Firefox. If the host machine 40 requests to read data D30 stored on the server 30, the data D30 is first transmitted to the card 10, and the card 10 then transmits the data D30 to the host machine 40, as if this data was coming exclusively from the card 10. If two folders on the card and on the remote server have the same name, the local and remote files will be presented in the same folder.

According to a first alternative embodiment, the unique list UL of data can be drawn up as a unified view of the data in FTP or WEBDAV format. The unique list UL is then displayed on the host machine by a conventional file explorer, such as the Windows Explorer, for example.

According to a second alternative embodiment, specific software can be previously installed on the host machine. The unique list UL of data can be drawn up as a unified view of the data in a standardised format, such as FTP or WEBDAV, or in a specific format. After transmission, the unique list UL is displayed on the host machine by the specific software.

According to one alternative embodiment, the unique list UL of the data is drawn up by the chip card 10 without setting up a data-exchange session with the remote server 30. The card 10 then uses the data D11 that list the remote data to draw up the unique list UL of data stored on the actual card and on the server. This solution improves the card's response time to the initial request of the host machine.

According to one alternative embodiment, the card tries to set up a data-exchange session with the remote server 30 but only uses the data D11 that list the remote data to draw up the unique list UL of data stored on the actual card and on the server. With the unique list UL, the card can transmit additional information relating to the status of the link between the card 10 and the remote server 30. The host machine can use this additional information to tell the user whether or not the data of the unique list is immediately accessible.

According to another variation, after setting up a data-exchange session between the chip card 10 and the remote server 30, the data D34 listing the data D30 stored on the server 30 is sent to the card 10. The card can then update the data D11 that list the remote data D30 according to the data D34 received. This operation guarantees synchronisation between the data of the server 30 and the corresponding list stored in the card. In the same way, the card 10 can store a copy of some of the remote files which were last accessed or which are most frequently accessed.

FIG. 2 shows an example of how the card draws up the unique list UL. In this case, the card 10 draws up a unique list UL containing information indicating the location of all the data in the list. This allows the host machine to present the user with an indication that specifies the medium on which each set of data is located. By means of a unified view on the host machine 40, the user can, in this case, know whether data is located on the card 10 or on the remote server 30. The indication can be made, in particular, in the form of a special icon or a specific colour code.

To guarantee confidentiality, access to the card data 10 can be subject to a verification of access conditions AC1. In this case, the configuration of the card can foresee that setting up a data-exchange session between the card 10 and the remote server 30 is subject to the success of the verification of access conditions AC1. Thus, the card 10 will only be able to access the data on the server 30 if the user has entered the correct access conditions. The access conditions AC1 can be stored in data D13 located in the data store MEM1 of the card 10.

Furthermore, the data D30 stored on the server 30 can, in turn, be protected by specific access conditions AC3. In this case, once the data-exchange session has been set up between the card 10 and the remote server 30, the card 10 transmits a request to activate the access conditions AC3 to the server 30. To configure this request, the card 10 uses the data D12 containing the access information for the remote data. This activation of the access conditions for the server data is automatically launched by the card. The automation is advantageous, in particular, when the access conditions AC1 for the data of the card are different from the access conditions AC3 for the data of the server 30. This mechanism can conceal the specific processes required to access remote data, thus saving the user from having to manage the access conditions for remote data. The access conditions can, in particular, include entering a secret code or setting up a key-based authentication. A further advantage of the invention is that it offers the user the guarantee that the data will only be accessible when the card is inserted in the host machine.

Optionally, the server 30 can contain data D33 relating to the access conditions AC3 for the data D30 on the server 30. The card 10 can transmit a request to the server 30 in order to modify the data D33 to authorise a second portable device 20 to access the data D30. The second portable device is of the same type as the card 10, which is to say that the second device 20 also integrates the invention. The second device 20 can have a different shape factor to that of the card 10. For example, the second device 20 can be a USB pen drive. The USB pen drive 20 contains a microprocessor 71, a data store MEM2 containing application data D20 and data D22 containing access information for the remote data. Delegating access to the USB pen drive 20 allows the user of the card 10 to share all or part of the data D30 stored on the remote server 30 with the user of another portable device. The USB pen drive 20 can access the data D30 on the remote server 30 via a second host machine 41 connected to the server 30. Shared access can be awarded in the form of read-only or read/write authorisation for one or more users.

Optionally, the server 30 can contain data D38 listing the data D20 stored on the USB pen drive 20. The server 30 can transmit the data D38 to the card 10. The card can then update the data D11 that list the remote data D30 according to the data D38 received. This operation guarantees synchronisation between the list of remotely accessible data and the corresponding data D11 stored in the card.

In addition, the remote server 30 can contain data D32 relating to the access information for the data D10 stored on the card 10. The server 30 can transmit the data D32 to the USB pen drive 20. In this case, data D22 containing access information for the remote data are updated in the USB pen drive 20 according to the data received D32. This operation guarantees synchronisation between the access information for data located on another card and the corresponding data D22 stored in the USB pen drive 20. This mechanism allows user to share data securely with other users.

Another advantage of the invention is that it grants access via a portable device 10 to data written directly onto another portable device 20 or onto a remote server 30.

Alternatively, the card 10 can delegate some of the processes it normally performs in the host machine 40. For example, the card 10 can generate a script that it transmits to the host machine 40. The host machine 40 can then interpret and execute this script in order to perform authentication with the remote server 30.

The size of the data store MEM3 located in the remote server 30 can be dynamically modified by a server administrator. For example, the size allocated to the data store MEM3 can be increased to allow the user of the card 10 to have extra memory space for storing a larger amount of data.

Another advantage of the invention is that it provides a unified view of files stored in file systems that are different from one medium to another. For example, the file system can be NTFS on the remote server 30 and FAT16 on the card 10.

The portable electronic device 10 can be connected to the host machine 40 by a wired or wireless link.

Optionally, at the request of the user or automatically, the USB pen drive 20 can send the remote server 30 the data it contains in order for the server to create a backup copy of the data thus transmitted. The server 30 can backup the data in a dedicated and/or secure data store. Once correctly authenticated, the user can subsequently and exactly recreate the contents of the USB pen drive by accessing the data backed up on the server.

A final advantage of the invention is that it allows the user to search for a given file without needing to know whether the file is stored on the card 10 or on the remote server 30.

1. Method for managing data of a portable electronic device connected to a host machine, said device containing a first set of data, the host machine being connected to a remote data server containing a second set of data, said method comprising the steps of:
drawing up, in the device, a unique list containing the first and second sets of data,
transmitting the unique list from the device to the host machine.

2. Method according to claim 1, in which a third set of data is stored persistently on the device, said third set of data listing the second set of remote data, and in which the unique list is drawn up according to the first and third sets of data.

3. Method according to claim 1, in which said remote server contains a fourth set of data listing the second set of data stored on the remote server, and in which drawing up the unique list includes the steps of:
setting up a data-exchange session between the device and the remote server via the host machine,
transmitting said fourth set of data from the remote server to the device,
drawing up the unique list using the first and fourth sets of data in the device.

4. Method according to claim 2, in which, after setting up a data-exchange session between the device and the remote server, a fourth set of data listing the second set of data stored on the remote server is transmitted to the device, and then the third set of data listing the second set of remote data stored on the remote server is updated in the device according to the fourth set of data received.

5. Method according to claim 1, in which, following a request to read remote data emitted by the host machine, data stored on the remote server is initially transmitted to the device by the server, and then transmitted by said device to the host machine.

6. Method according to claim 1, in which the unique list of data transmitted to the host machine contains information indicating the location of each set of data in the list.

7. Method according to claim 3, in which access to the first set of data stored in the device is subject to the verification of access conditions, and in which setting up a data-exchange session between the device and the remote server is subject to the success of the verification of said access conditions.

8. Method according to claim 3, in which the remote server contains data relating to access conditions associated with a third set of data stored on the remote server, and in which the verification of said access conditions is automatically activated by the device.

9. Method according to claim 8, in which the device contains access information for the data of the remote server, and in which, after setting up a data-exchange session between said device and the remote server, the data relating to the access conditions are transmitted to the device, and said access information for the data of the remote server is then updated in the device according to the data received.

10. Method according to claim 8, in which the data relating to the access conditions are modified by a first device to authorise a second portable electronic device of the same type as the first device to access said second set of data.

11. Method according to claim 10, in which the remote server contains a fifth set of data listing the data stored on a second portable device, and in which, after setting up a data-exchange session between the first device and the remote server, said fifth set of data is transmitted to the first device, and then the third set of data listing the remote data is updated in the first device according to the fifth set of data received.

12. Method according to claim 10, in which the remote server contains access information for data stored on the second device, and in which, after setting up a data-exchange session between the first device and the remote server, said access information for data stored on the second device is transmitted to the first device, and then data containing access information for remote data is updated in the first device according to the access information received.

13. Portable device designed for being connected to a host machine, comprising a microprocessor and a data store containing a first set of data, said host machine being designed for being connected to a remote server containing a second set of data, wherein said device includes means for drawing up a unique list containing the first and second sets of data and means for transmitting the unique list to the host machine.

14. Portable device according to claim 13, wherein said device contains a third set of data listing the second set of data located on the remote server.

15. Portable device according to claim 13, wherein said device contains access information for the data of the remote server.

16. Portable device according to claim 13, wherein said device is a chip card or a USB pen drive for storing data.

17. Server designed for being connected to a host machine, comprising a microprocessor and a data store containing remote data, said host machine being designed for being connected to a portable device according to claim 13, said device containing local data, wherein the server contains means for transmitting a response to a request of the device, after setting up a data-exchange session between the device and the server, said response containing data listing the remote data.
